(19) United States
(12) Patent Application Publication
(10) Pub. No.: US 2012/0259257 A1
(43) Pub. Date: Oct. 11, 2012

(54) ROLLER MASSAGE AND PRESSURE POINT MASSAGE SYSTEM

(76) Inventor: Gordon L. Nelson, Ogden, UT (US)

(21) Appl. No.: 13/437,236

(22) Filed: Apr. 2, 2012

Related U.S. Application Data
(60) Provisional application No. 61/471,815, filed on Apr. 5, 2011.

(51) Int. Cl. A61H 15/00

(52) U.S. Cl. 601/119

(57) ABSTRACT

The present invention includes roller massage systems that are adjustable for individual comfort and use and methods related thereto. In one illustrative embodiment, a roller is centrally located on a generally U-shaped framework formed by two opposite symmetrical handles. Each handle may end in a rounded knob to allow for massage with pressure applied at particular points and may be disposed at a particular angle from the remainder of the handle for advantageous use. The roller may be interchangeable to allow a variety of rollers to be utilized providing different forms of massage. The handles may be adjustable at different points to allow users of different sizes to utilize the system.

### CROSS-REFERENCE TO RELATED APPLICATION

This application claims the benefit of U.S. Provisional Application No. 61/471,815 filed Apr. 5, 2011, the disclosure of which is incorporated herein by reference in its entirety.

### TECHNICAL FIELD

The present invention relates to manually applied body and massage tools.

### BACKGROUND

Many implements for body massage have been developed and used, including powered vibrating implements with rounded knobs and unpowered tools having rounded knobs and studded rollers. However, typical massage implements are either designed to be used on a person receiving a massage by a second person providing the massage, or are designed to be applied to a particular portion of the body (such a foot) by a single person providing their own massage. Attempts to massage hard to reach places on one's own body may be difficult, if not impossible and can require contortions that a person with a sore muscle may find impracticable. This can create difficulty for a single individual to massage particular portions of the body without the assistance of a second person.

Some prior attempts to allow a person to self massage include the devices and systems disclosed in U.S. Pat. Nos. 1,533,528; 2,168,975; 5,364,338; 5,577,996; 5,730,708; 6,241,693; 6,332,873; and 6,988,997; as well as US Published Patent Application 2007/0287938, the disclosure of each of which is incorporated by reference herein in its entirety. However, each of these designs is limited.

A system that allowed a single user to provide controlled massage to hard to reach portions of their own body with minimal difficulty would be an improvement in the art. Such a system that provided for different types of massage in a single apparatus would be a further improvement in the art and a system that was adjustable to allow controlled use by users of different sizes would be an additional improvement in the art.

### SUMMARY

The present invention includes roller massage systems that are adjustable for individual comfort and use and methods related thereto. In one illustrative embodiment, a roller is centrally located on a generally U-shaped framework formed by two opposite symmetrical handles. Each handle may end in a rounded knob to allow for massage with pressure applied at particular points and may be disposed at a particular angle from the remainder of the handle for advantageous use. The roller may be interchangeable to allow a variety of rollers to be utilized providing different forms of massage. The handles may be adjustable at different points to allow users of different sizes to utilize the system and may be collapsible for storage and portability.

### DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims, and to the several drawings.

FIG. 1 is a perspective view of a first embodiment of an assembled system in accordance with the principles of the present invention.

FIG. 2 is a top view of the system of FIG. 1.

FIG. 3 is a side view of the system of FIGS. 1 and 2.

FIG. 4 is a perspective view the system of FIG. 1 assembled with an alternative embodiment of a roller assembly.

FIG. 5 is a perspective view of two embodiments of roller assemblies that may be used with systems as depicted in FIGS. 1 through 4.

FIG. 6 depicts components of systems depicted in FIGS. 1 through 5 in an unassembled state.

FIG. 7 depicts a system in accordance with FIGS. 1 through 6 and a storage rack therefore.

FIGS. 8 through 11 depict some potential uses of the systems of FIGS. 1 through 7.

FIG. 12 depicts an alternative embodiment of a roper assembly useful in the present invention that features multiple massage options on a single roller.

### DETAILED DESCRIPTION

The present invention relates to systems and methods for personal massage that are adjustable for individual comfort and use. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. All such alternate embodiments are within the scope of the present invention.

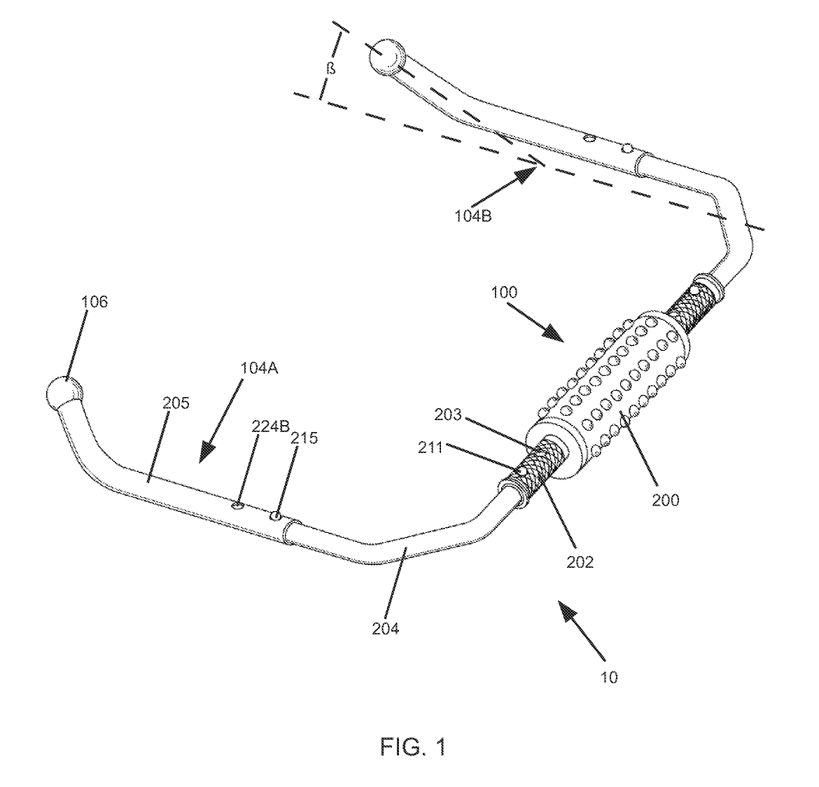

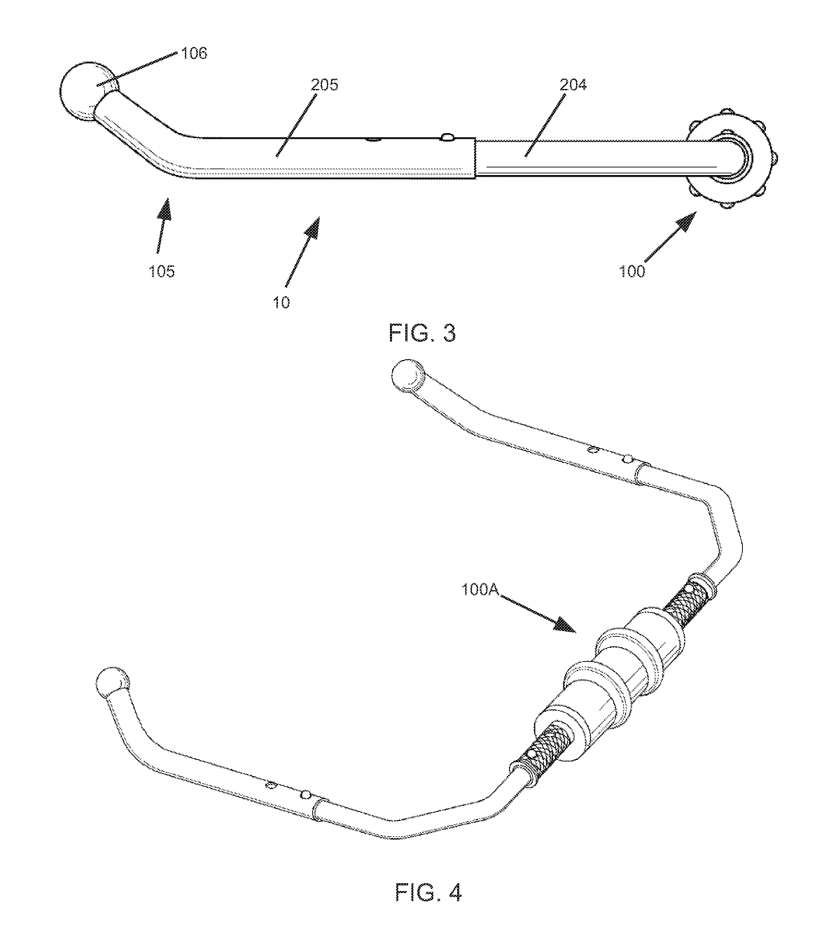

Referring to FIGS. 1 to 3, a first embodiment of an assembled system 10 in accordance with the principles of the present invention is depicted. In the assembled illustrative embodiment 10, a roller assembly 100 is centrally located on a generally U-shaped framework formed by two opposite symmetrical handles 104A and 104B. Each handle 104 may end in a rounded knob 106 to allow for massage with pressure applied at particular points.

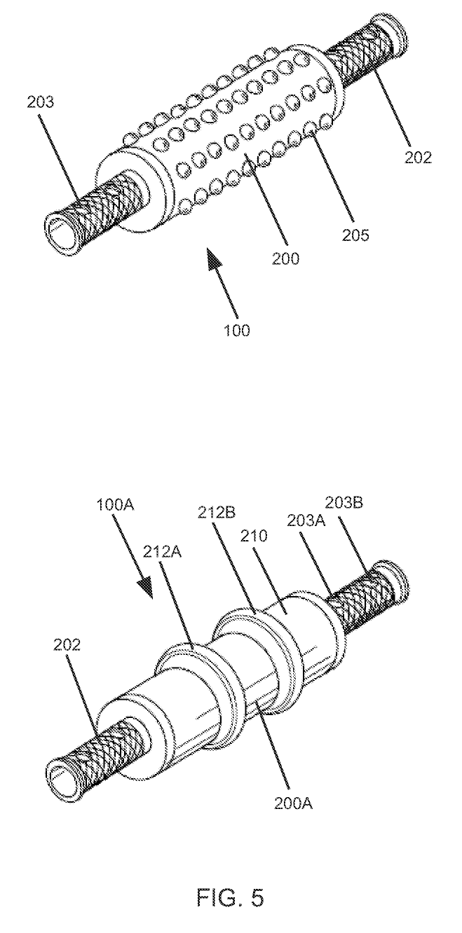

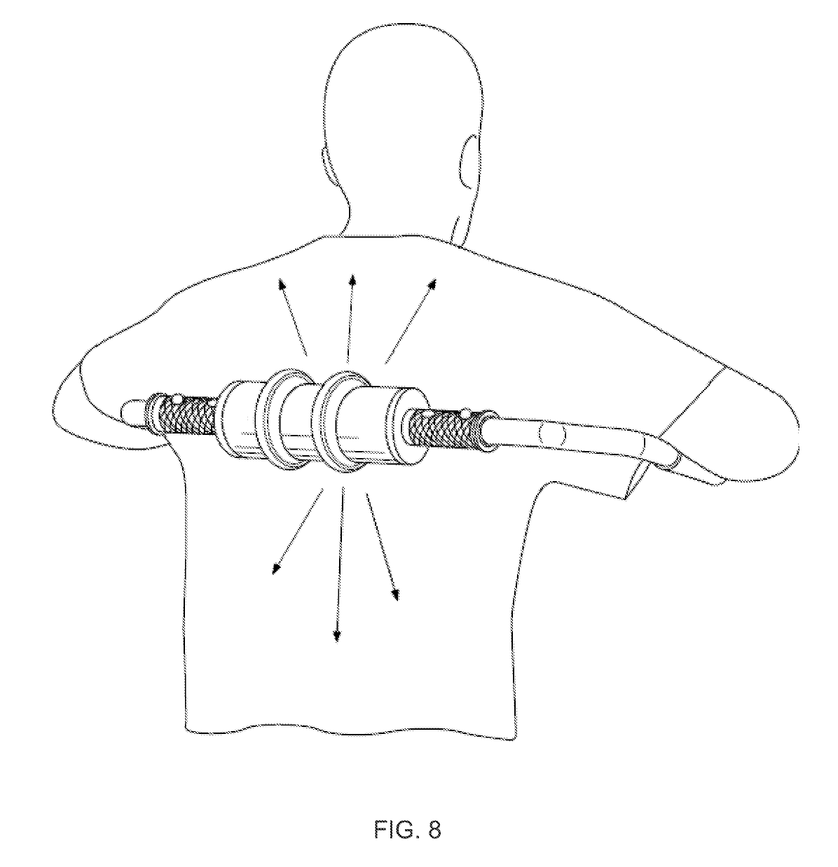

Roller assembly 100 may include a central roller portion 200 that generally comprises a cylinder which is rotatably disposed on an axle 202. Each end of axle 202 protrudes past the cylinder and includes a structure, such as connection hole 203 allowing the roller assembly 100 to be attached to the handles 104. It will be appreciated that the cylinder portion of roller assembly 100A (FIG. 4) in one embodiment may vary to allow for different types of a massage to be applied. FIG. 5 depicts two different roller assemblies 100 and 100A having varying surfaces on the cylinder portions 200 and 200A, including smooth surfaces 210, raised disks 212A and 212B, and a studded surface with individual raised nubs 205. In the depicted embodiments, the raised disks 212A and 212B may be used to simultaneously apply rolling pressure on a user's back on opposite sides of the spine, as depicted in FIG. 8.

It will be appreciated that for different embodiments, roller portions having varying diameters, as well as varying firmness, from rigid cylinders to those constructed from foam or other thermoplastic materials or having a cushioned surface may be used. It will be appreciated that a system 10 in accordance with the present invention may include a number of such interchangeable roller assemblies to allow a variety of rollers to be utilized with a single system so that different forms of massage can be provided.

Further, it will be appreciated that a roller assembly 100 may be used by grasping the protruding ends of the axle 202 without the attached handle assembly, as depicted in FIG. 5. This allows one person to easily apply the roller to a second person, without the attachable handles obstructing such application.

Additionally, it will be appreciated that where desired, the roller assembly may have a receptacle into which a battery powered vibratory assembly can be placed to provide a vibratory action to the roller. Alternatively, the axle 202 may contain such a receptacle.

In the depicted embodiments, each handle 104 may be formed from two sections, a proximal section 204 and a distal section 205. The proximal section 204 may be formed as a tube the ends of which are coplanar, but are generally orthogonal to one another from an angle of about 90 degrees that may be formed as a gradual curve over a medial section of the tube, or may be formed by two generally 45 degree angles disposed a small distance apart from one another over the medial section of the tube.

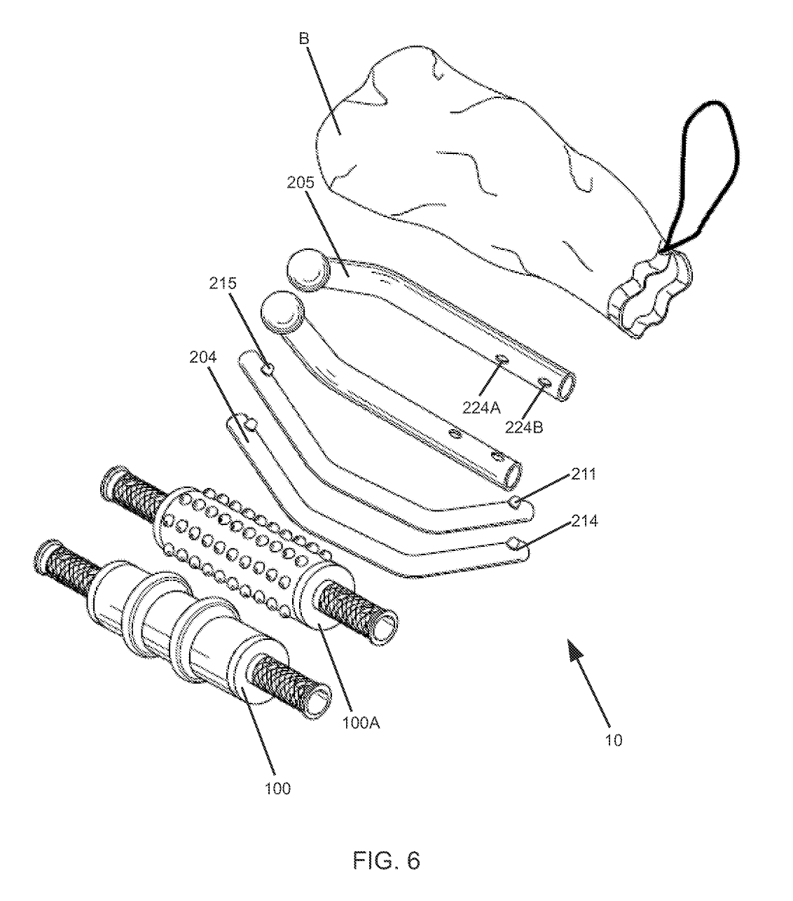

At a proximal end for attaching the roller assembly 100, the proximal section 204 includes a structure for connecting to the roller assembly. In the depicted embodiments, the proximal section 204 (FIG. 6) may contain a knob 211 or pin that extends out of a connection hole 214 when urged thereby by a resilient member such as a spring. A user may depress the knob 211 and then simply align the connection hole 214 with the connection hole 203 on the roller axle 202 and allow the knob 211 to “click” into place connection hole 203 to maintain the connection thereto. It will be appreciated that in alternative embodiments, without knob 211, a pin such as a cotter pin, may be inserted through the aligned connection holes to retain the members together. Additionally, in another alternative embodiment, the axle may be inserted into the handle.

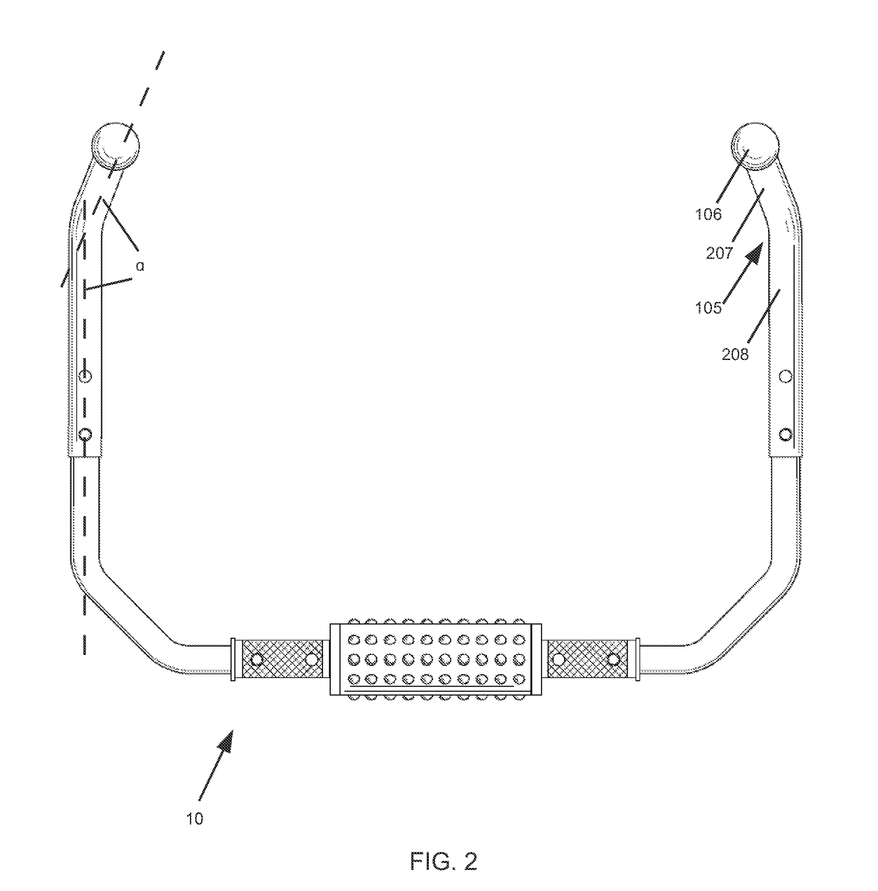

As best depicted in FIG. 2, there may be multiple connection holes 203 spaced apart on the axle 202, this allows the distance to the curve and thus the distance between the handles 104 to be selectably varied by an assembling user. It will be appreciated that the multiple connection structures may be placed on the axle, the proximal member or both.

Near the distal end of the proximal section 204, similar connection structures, such as connection hole 214 and retractable knob or pin 215 may be disposed through the wall of the tube.

Distal handle section 205 of handle 104 may similarly be formed as a tube that extends from a proximal end that extends along a first axis a distal end terminating in rounded knob 106. A central bend 105 is (FIG. 2) disposed between the proximal end and distal end, defining a proximal section 208 and a distal section 207. In a first common plane defined by the long axes of the proximal section and the distal section, the angle α (FIG. 2) of the central curve is such that the axes of the distal and proximal sections are at an angle of about 45 degrees with respect to one another. It will be appreciated that the central bend 105 may be formed as a gradual curve where desired for aesthetics.

Upon assembly, the distal section 207 of the distal handle section 205, extends inwardly towards the center of the U shaped frame formed by handles 104 and roller assembly 200 in an upwards direction. From a plane defined by the long axes of the proximal section 204 and the roller assembly 200, the rounded knob 106 at the distal end extends upwards at an angle β (FIG. 1) of from about 30 degrees to about 60 degrees. In some current embodiments, this angle may be about 45 degrees, in connection with angle α of the central curve described previously herein, this maintains the rounded knob 106 at a particular angled position from the remainder of the handle and system for advantageous use in applying pressure massage to a particular point, as described further herein.

Additionally, it will be appreciated that the rounded knob 106 may be removable and a receptacle or connection structure disposed within the distal section 205 into which a battery powered vibratory assembly can be placed to provide a vibratory action to the rounded end.

Near the proximal end, the distal section 205 includes one or more structures, such as connection holes 224A and 224B, for connecting to the proximal section 204. In the depicted embodiments, the distal end of section 204 may be inserted into the open end of proximal section 205 such that the connection holes 224A or 224B and 214 align. As depicted, a knob 215 or pin that extends out of a connection hole 214 when urged thereby by a resilient member such as a spring may be depressed by a user may depress the knob and then align the connection holes to have it “click” into place. It will be appreciated that in alternative embodiments, a pin such as a cotter pin, may be inserted through the connection holes to retain the members together. Further, in some alternatives, the proximal end of the distal section 205 may be inserted into the distal end of the proximal section 204.

Where distal handle section 205 contains multiple connection holes 224 to connect the distal section 205 and proximal section 204 of handle 104, this allows the length of the handles and the distance from the rounded knob 106 to the roller assembly 100 to be selectably varied by an assembling user.

As depicted, the components of systems in accordance with the present invention may be constructed from any suitable materials, including plastics, metals and combinations thereof.

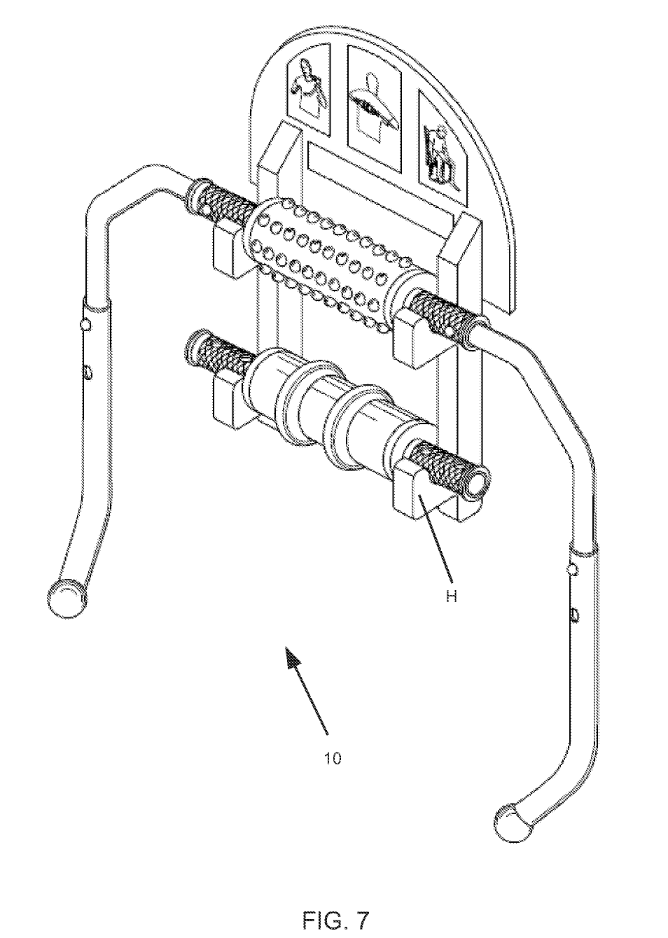

Additionally, as depicted in FIGS. 6 and 7, systems of the present invention may be sold as a set including a number of roller assemblies 200 together with a set of handles 104 to form a framework 102. A rack H may be provided with the system into which the various rollers can be placed on the shelves thereof, with a roller to which the handles are attached placed in the uppermost shelf with the handles extending downwards around the rack. This can provide for convenient storage, display of the system and packaging for shipping and sales. A bag B may also be provided allowing for easier transport of a disassembled system

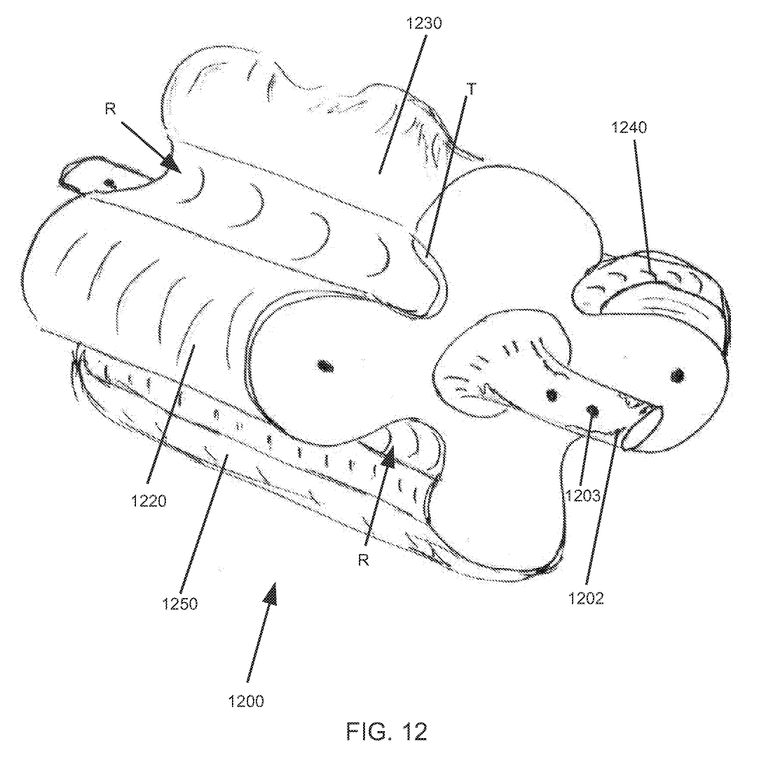

Another embodiment of a roller assembly is depicted in FIG. 12. Such an assembly includes a recessed roller 1200 having a number of protruding massage portions with recessed portions R in-between. As depicted, there may be four recessed portions R which may be sized to retainably receive the handle 104 components (distal handle section 205 and proximal section 204) for storage. Each recess may include tabs T or other structures therein to releasably retain the handle components.

Separated by recesses R are a number of protruding massage portions. In the depicted embodiment, these include a single roller 1220 fixed on an axle, a textured protrusion with covering nubs 1230, a set of rolling wheels that are fixed on an axle 1240 and a smooth surfaced protrusion 1250 having a half moon cross-sectional shape. The central body of roller 1200 is attached to an axle 1202 for joining to the handle portion 104 of a system 10 in accordance with the present invention, including connection holes 1203. It will be appreciated that each of the protruding portions may be “locked” into a desired position, such that it faces into the U of an assembled system 10, allowing the surface thereof, such as the nubs or one or more rollers disposed on an axle to be used by a user.

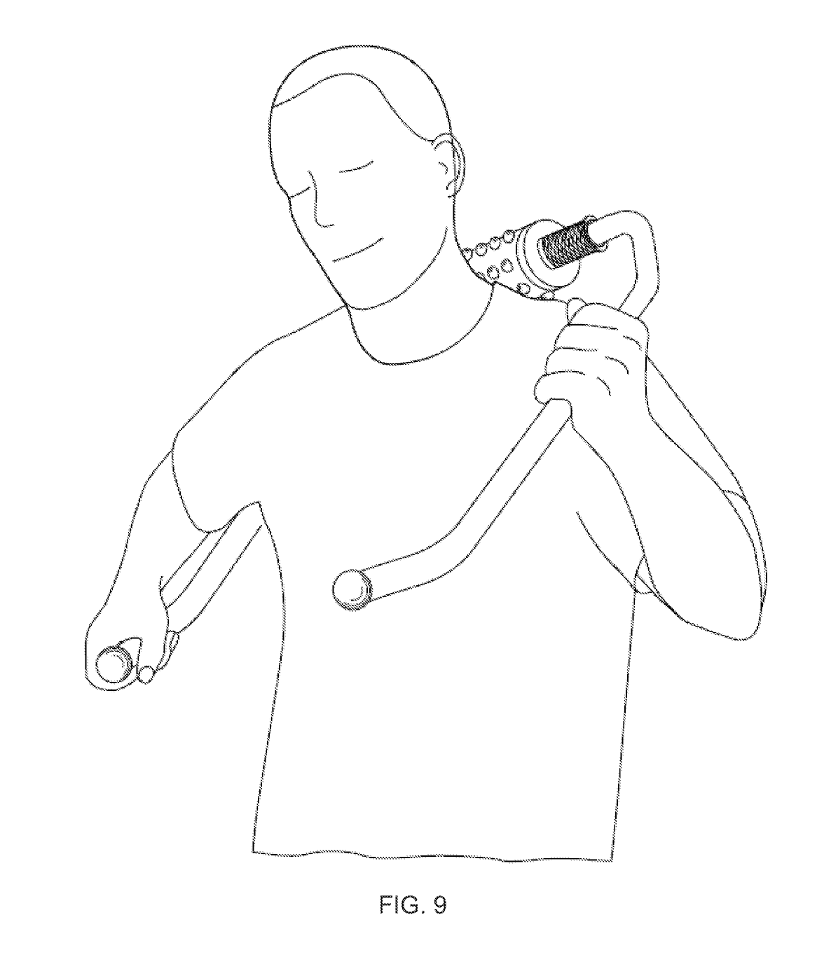

Some potential uses of a system 10 in accordance the present invention are depicted in FIGS. 8 through 11. For use, a user can assemble a system 10 in accordance the present invention, grasp the handles 104 in front with the roller assembly disposed behind their back, and apply the roller assembly to their back or neck as depicted in FIGS. 8 and 9. The position and shape of the handles 104 allows for leverage to control the application of pressure and the location of the roller 200 on the user's back or neck.

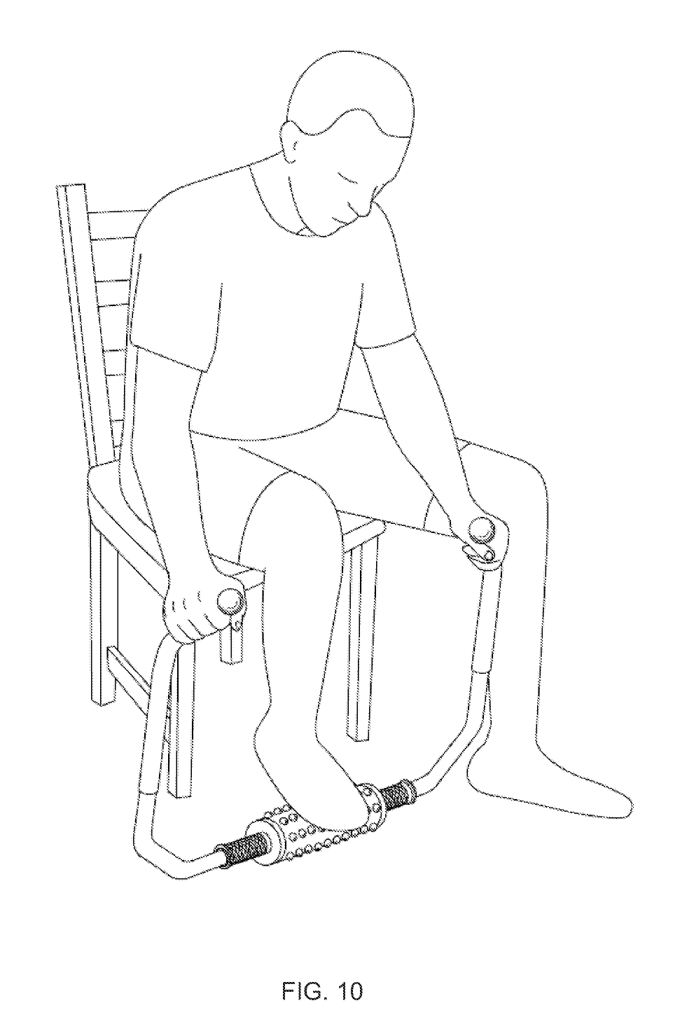

Additionally, a user may grasp the handles with the system vertically disposed and the roller assembly disposed at the bottom of the U, and then apply the roller assembly to feet or legs. The position and shape of the handles allows for leverage to control the application of pressure and the location or the roller on the user's lower legs or feet, especially in a seated position, as depicted in FIG. 10. Additionally, the roller assembly may be placed in the floor and the handles used to provide a controlled massage to the bottom of the foot.

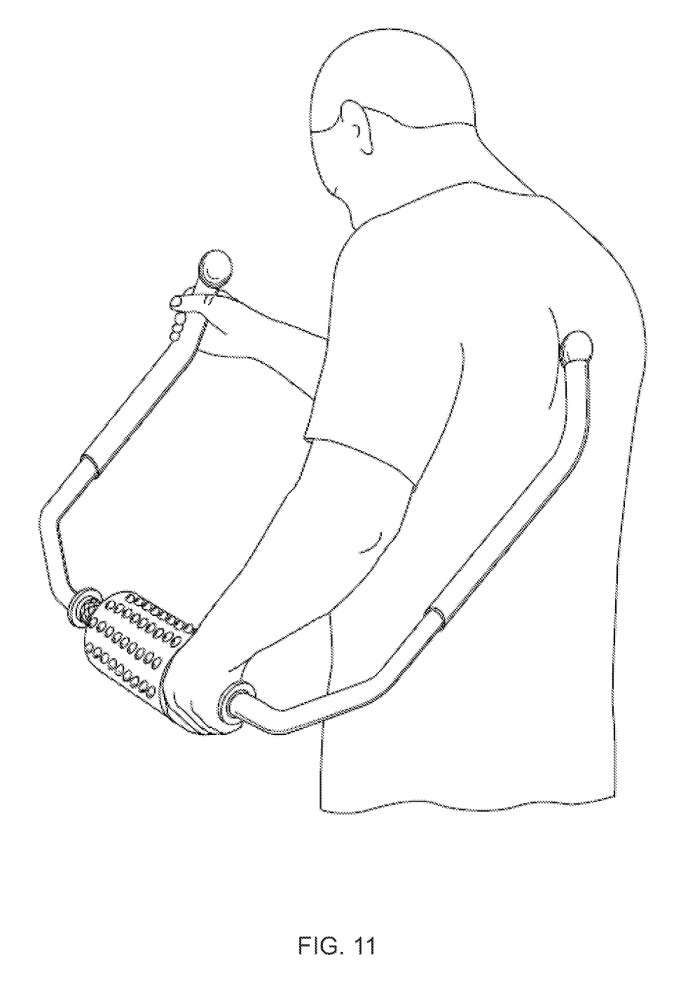

It will be appreciated that for other areas of the body, a roller assembly 200 may be directly used without the handles 104.

Where more intensive pressure is desired, a rounded knob 106 disposed on the distal end of a handle 104 may be used to provide massage. As depicted in FIG. 11, the position of the rounded knob 106 with respect to the remainder of the handles 104 of the generally U-shaped system 10 allows a user to easily reach all areas of the back and to use leverage to apply a pressure of desired intensity thereto. As depicted, the exposed portion of axle 202 of roller assembly 200 may be used as a handle that functions as a pivot point or fulcrum for the application of such pressure. It will be appreciated that the surface of such axle 202 may be textured to provide an appropriate grip for the user. For example, a non-slip grip, such as a rubber or silicone sleeve with a textured surface may be disposed on the axle 202 to provide the texture.

While this invention has been described in certain embodiments, the present invention can be further modified with the spirit and scope of this disclosure. This application is therefore intended to cover any variations, uses, or adaptations of the invention using its general principles. Further, this application is intended to cover such departures from the present disclosure as come within known or customary practices in the art to which this invention pertains and which fall within the limits of the appended claims.

What is claimed is:

1. A roller massage system, comprising:
a roller assembly,
a generally U-shaped framework formed by two opposite handles which extend in a common plane from the roller assembly opposite one another curving to extend generally orthogonally from the roller assembly and parallel to one another to form the U-shaped framework;
at least a first rounded knob disposed on a distal end of one of the two opposite handles, wherein a distal section of the one handle contains a central bend that places the long axis of a distal portion of the distal section at an angle of about 45 degrees from the long axis of the section of the handle which is orthogonal to the roller assembly in a common plane defined by the long axes of the distal portion and the orthogonal section and the distal portion extends inwardly towards the center of the generally U-shaped framework.

2. The roller massage system of claim 1, wherein the distal portion extends inwardly towards the center of the generally U-shaped framework at an angle of from about 30 degrees to about 60 degrees upwards from a plane defined by the long axes of the roller assembly and the section of the handle which is orthogonal to the roller assembly.

3. The roller massage system of claim 2, wherein the distal portion extends inwardly towards the center of the generally U-shaped framework at an angle of about 45 degrees upwards from a plane defined by the long axes of the roller assembly and the section of the handle which is orthogonal to the roller assembly.

4. The roller massage system of claim 1, wherein the roller assembly comprises a roller disposed on an axle.

5. The roller massage system of claim 4, wherein the roller assembly roller has a nubbed surface or a pair of raised ridges.

6. The roller massage system of claim 4, wherein the roller assembly is an interchangeable assembly which can be releasably connected to the handles by connecting each handle to a respective end of the axle.

7. The roller massage system of claim 6, wherein the system comprises at least a second interchangeable roller assembly that can be releasably connected to the handles by connecting each handle to a respective end of the axle.

8. The roller massage system of claim 4, wherein the axle extends past the roller symmetrically on both sides and has a textured surface to facilitate gripping.

9. The roller massage system of claim 4, wherein the roller assembly roller comprises a roller with multiple protruding massaging portions separated by recesses which can be locked into a fixed position.

10. The roller massage system of claim 9, wherein the two opposite handles each comprises two releasable connection pieces, which can be inserted into the recesses of the roller for storage when in a disassembled state.

11. The roller massage system of claim 1, wherein the handles are adjustable at different points to after the length of the handles and the width of the generally U-shaped framework.

12. The roller massage system of claim 11, wherein each handle comprises:
a distal portion formed as a tube having a distal end closed by the rounded knob and a proximal end, wherein the distal portion includes a set of connection structures disposed near the proximal end; and
a proximal portion formed as a tube having a first end and a second end which are orthogonal to each other in a common plane, with a first connection structure disposed near the first end which releasably attaches the proximal portion to the axle of the roller assembly by interaction with one of a set of corresponding structures on the roller assembly axle to connect thereto and maintain the second end at a desired distance from the roller assembly and a second connection structure disposed near the second end which releasably attaches the proximal portion to the distal portion by interaction with one of the set of connection structures disposed near the proximal end the distal portion to connect thereto and maintain the distal end of the distal portion at a desired length from the roller assembly.

13. The roller massage system of claim 12, wherein the set of connection structures disposed near the proximal end of the distal portion of the handle and the set of corresponding structures on the roller assembly axle each comprise sets of holes through the sidewalls of tubes and the first connection structure and second connection structure on the proximal portion each comprise retractable knobs that extend through a selected connection hole.

14. The roller massage system of claim 1, further comprising a second rounded knob disposed on a distal end of the second of the two opposite handles, wherein a distal section of the second handle contains a central bend that places the long axis of a distal portion of the distal section of the second handle at an angle of about 45 degrees from the long axis of the section of the second handle which is orthogonal to the roller assembly in a common plane defined by the long axes of the distal portion and the orthogonal section and the distal portion extends inwardly towards the center of the generally U-shaped framework.

15. The roller massage system of claim 14, wherein the distal portion extends inwardly towards the center of the generally U-shaped framework at an angle of from about 30 degrees to about 60 degrees upwards from a plane defined by the long axes of the roller assembly and the section of the second handle which is orthogonal to the roller assembly.

16. The roller massage system of claim 15, wherein the distal portion extends inwardly towards the center of the generally U-shaped framework at an angle of about 45 degrees upwards from a plane defined by the long axes of the roller assembly and the section of the second handle which is orthogonal to the roller assembly.

17. A method of using the roller massage system of claim 1 by a user to apply massage to the user, the method comprising:
grasping each of the two opposite handles by the user in front of the user;
placing the roller assembly behind user with the user positioned in the generally U-shaped framework; and
applying the roller assembly to back or neck of the user by manipulating the two opposite handles to control the application of pressure and the location of the roller assembly on the user's back or neck.

18. A method of using the roller massage system of claim 1 by a user to apply massage to the user, the method comprising:
grasping one of the two opposite handles by the user in front of the user;
grasping another portion of the generally U-shaped framework with a second hand of the user,
placing the second of the two opposite handles behind user with the user positioned in the generally U-shaped framework; and
applying the at least a first rounded knob to a back or a neck of the user by manipulating the generally U-shaped framework to control the application of pressure and the location of the at least a first rounded knob on the user's back or neck.

19. The method of claim 18, wherein grasping another portion of the generally U-shaped framework with a second hand of the user comprises grasping an axle portion of the roller assembly.

20. The method of claim 18, wherein the method further comprises assembling the roller massage system from a set of components prior to applying the massage.
